(19) United States
(12) Patent Application Publication
(10) Pub. No.: US 2024/0421619 A1
(43) Pub. Date: Dec. 19, 2024

(54) WIRELESS CHARGING DEVICE

(71) Applicant: Shenzhen Swanscout Innovations Technology Co., Shenzhen City (CN)

(72) Inventor: Junbao Li, Guangzhou City (CN)

(21) Appl. No.: 18/518,748

(22) Filed: Nov. 24, 2023

(30) Foreign Application Priority Data
Jun. 16, 2023 (CN) 2023215418931

(51) Int. Cl. H02J 7/00; H02J 50/00

(52) U.S. Cl. CPC H02J 7/0044; H02J 50/00

(57) ABSTRACT

A wireless charging device is provided, including a charging base, a charging bracket and a charging cantilever. The charging bracket is rotatably connected to the charging base, and when the charging bracket is unfolded with respect to the charging base, the charging bracket couples with the charging base to position a second product. The charging cantilever is rotatably connected to the charging bracket, and the rotation axis of the charging bracket is parallel to that of the charging cantilever. The wireless charging device is versatile and flexible due to its three forms. In the first form, the wireless charging device is easy to carry and can charge the second product; in the second form, at least one of the first product and the second product can be charged; in the third form, at least one of the first product, the second product and the third product can be charged.

### TECHNICAL FIELD

Frisbees present disclosure relates to the field of wireless charging, and in particular to a wireless charging device.

### BACKGROUND

With the development of technology, the use of electronic products has increased, resulting in more frequent charging. There exist two prevalent electronic product charging methods: wired charging through a charging cable and wireless charging. Since wireless charging eliminates the need for a charging cable, it is simpler and more convenient to use. Wireless chargers have a limitation of charging only one electronic device and cannot charge different types of devices simultaneously.

### SUMMARY

The purpose of the present disclosure is to provide a wireless charging device that can charge various electronic products.

In order to the aforementioned technical problems, the purpose of the present disclosure is accomplished through the following technical solutions:

A wireless charging device, which includes a charging base, a charging bracket and a charging cantilever. The charging base charges a first product. The charging bracket charges a second product. The charging bracket is rotatably connected to the charging base to cause the charging bracket and the charging base to be folded or unfolded with respect to each other. When the charging bracket is unfolded with respect to the charging base, the charging bracket is configured to couple with the charging base to position the second product. The charging cantilever is used for charging a third product. The charging cantilever is rotatably connected to the charging bracket to cause the charging cantilever and the charging bracket to be folded or unfolded with respect to each other. The rotation axis of the charging bracket is parallel to the rotation axis of the charging cantilever.

Further, a positioning slot is provided at a side of the charging base close to the charging bracket, and the positioning slot is configured to place the first product. When the wireless charging device is in a first form, at least a portion of the charging bracket and the charging cantilever are located in the positioning slot.

Further, the charging base includes a first housing, a battery, a control module and a first charging assembly. The first housing is rotatably connected to the charging bracket, and the first housing has a first accommodating space. The battery is disposed in the first accommodating space. The control module is disposed in the first accommodating space and located on one side of the battery, and the control module is electrically connected to the battery. The first charging assembly is disposed in the first accommodating space and connected to the control module.

Further, the first housing includes a first cover and a first plate, and the first cover and the first plate enclose to form the first accommodating space. The first cover is rotatably connected to the charging bracket. The first cover has a positioning table formed on an upper side thereof, and the positioning table is configured to couple with the charging bracket to position the second product.

Further, the positioning table has a first side and a second side intersected with the first side. The first side is configured to couple with the charging bracket to position the second product, and the second side is provided with an avoidance slot. The charging base further includes a display module disposed in the avoidance slot and connected to the control module.

Further, the first side is provided with a protective pad, and the first side is configured to couple with the charging bracket to locate the second product via the protective pad.

Further, the first plate is provided with a locating block, and the locating block is provided with a slot clamped with the display module.

Further, the charging bracket includes a second housing and a second charging assembly. The second housing is rotatably connected to the charging base, and the second housing has a second accommodating space. The second charging assembly is disposed in the second accommodating space, and the second charging assembly is configured to charge the second product.

Further, a side of the charging base close to the charging bracket is provided with a positioning slot. The second housing is provided with a mounting table protruding towards the charging base, and the mounting table is provided with a mounting slot. When the wireless charging device is in a first form, the mounting table is located in the positioning slot and the charging cantilever is located in the mounting slot.

Further, the mounting table is provided with a handle slot communicated with the mounting slot.

Further, the wireless charging device includes a rotating-shaft structure connected to the charging base and the charging bracket to cause the charging base and the charging bracket to rotate with respect to each other.

Further, the rotating-shaft structure includes a rotating-shaft seat and a damping spindle. The rotating-shaft seat is disposed at the charging base, and the rotating-shaft seat is provided with a through-hole. The damping spindle is threaded through the through-hole and connected to the charging bracket.

Further, the damping spindle includes: a first portion and a second portion. The first portion is located at one end of the rotating-shaft seat and threaded through the through-hole, and the first portion is connected to the charging bracket. The second portion is spaced apart from the first portion along the rotation axis of the charging bracket. The second portion is located at an opposite end of the rotating-shaft seat and threaded through the through-hole, and the second portion is connected to the charging bracket.

Further, the first portion includes a first shaft, a first connecting block, an elastic sheet and a fastening nut. The first shaft is threaded through the through-hole and connected to the rotating-shaft seat. The first connecting block is rotatably connected to the first shaft, and the first connecting block is fixedly connected to the charging bracket. The elastic sheet is threaded through the first shaft and in direct contact with the first connecting block. The fastening nut is threadedly connected to the first shaft.

Further, the first connecting block is provided with an angular-limiting block, the first shaft is provided with an angular-limiting ring, and the angular-limiting block is in contact with the angular-limiting ring to limit the rotation range of the charging bracket.

Further, the second portion is provided with a fixing block, and the rotating-shaft seat is provided with a plurality of fixing slots spaced apart around the rotation axis of the charging bracket. The first portion and the second portion are both slidingly connected to the rotating-shaft seat and the sliding direction thereof extends in a direction of the rotation axis of the charging bracket, so as to cause the fixing block to extend into or to disengage from one of the fixing slots. When the fixing block extends into a fixing slot, the rotation of the charging bracket is limited; when the fixing block is disengaged from the fixing slot, the charging bracket can rotate with respect to the charging base.

Further, the rotating-shaft structure includes a spring sleeved to the first portion, and the spring is configured to push the first portion such that the fixing block extends into the fixing slot.

Further, the charging cantilever includes a third housing and a third charging assembly. The third housing is rotatably connected to the charging bracket, and the third housing has a third accommodating space. The third charging assembly is located in the third accommodating space, and the third charging assembly is electrically connected to the control module to charge the third product.

Further, the charging cantilever is slidably connected to the charging bracket, and when the charging bracket is folded with the charging base, the charging cantilever can slide with respect to the charging bracket and extend out of the charging bracket.

Further, the first product is an earbuds charging compartment, the second product is a cell phone, and the third product is a watch.

The wireless charging device has a first form, a second form and a third form. When in the first form, the wireless charging device can be easily carried and can charge the second product. When in the second form, at least one of the first product and the second product can be charged. When in the third form, at least one of the first product, the second product and the third product can be charged. The wireless charging device is versatile and flexible.

### BRIEF DESCRIPTION OF THE DRAWINGS

In order to more clearly illustrate the technical solutions of the embodiments of the present disclosure, the drawings needed to be used in the description of the embodiments will be briefly introduced below. Obviously, the drawings in the following description are some embodiments of the present disclosure. Those of ordinary skill in the art can also obtain other drawings based on these drawings without exerting creative work.

FIG. 1 is a perspective view of a wireless charging device according to one embodiment.

FIG. 2 is a perspective view of the wireless charging device according to another embodiment.

FIG. 3 is a perspective view of the wireless charging device of FIG. 1 in a first form.

FIG. 4 is a perspective view of the wireless charging device of FIG. 1 in a second form.

FIG. 5 is a perspective view of the wireless charging device of FIG. 1 in a third form.

FIG. 6 is a perspective view of the wireless charging device according to another embodiment.

FIG. 7 is an exploded view of the wireless charging device of FIG. 1.

FIG. 8 is an exploded view of another angle of the wireless charging device of FIG. 1.

FIG. 9 is a perspective view of a portion of the wireless charging device of FIG. 1.

FIG. 10 is an exploded view of a rotating-shaft structure of FIG. 1.

FIG. 11 is an exploded view of the rotating-shaft structure according to another embodiment.

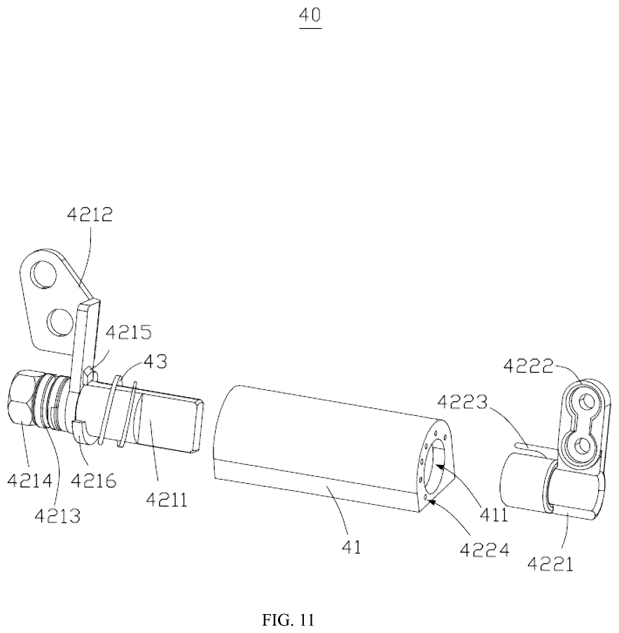

FIG. 12 is an exploded view of a charging cantilever of FIG. 1.

FIG. 13 is a top view of the wireless charging device according to another embodiment.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are part of the embodiments of the present disclosure, rather than all of the embodiments. Based on the embodiments in the present disclosure, all other embodiments obtained by those of ordinary skill in the art without creative efforts fall within the scope of protection of the present disclosure.

It should be understood that, when used in this specification and the claims, the terms “comprise” and “include” indicate the presence of described features, integers, steps, operations, elements and/or components but do not exclude the presence or addition of one or more other features, integers, steps, operations, elements, components and/or sets thereof.

It should also be understood that the terminology used in the specification of the present disclosure is for the purpose of describing particular embodiments only and is not intended to be limiting of the disclosure. As used in this specification and the appended claims, the singular forms “a”, “an” and “the” are intended to include the plural forms unless the context clearly dictates otherwise.

It will be further understood that the term “and/or” as used in this specification and the claims refers to and includes any and all possible combinations of one or more of the associated listed items.

In the various figures, the following components are included.
100, wireless charging device;
10, charging base; 11, first housing; 111, first cover; 1111, connecting strip; 1112, clamping block; 1113, first mounting position; 1114, second mounting position; 1115, positioning slot; 112, first plate; 1121, first heat-dissipation hole; 1122, sealing strip; 1123, connecting slot; 1124, positioning block; 11241, slot; 1125, spacer; 110, first accommodating space; 113, positioning table; 1131, first side; 1132, second side; 1133, protective pad; 1134, avoidance slot; 12, battery; 13, control module; 14, first charging assembly; 141, first induction coil; 142, first master control member; 15, display module; 16, key module; 17, charging module;
20, charging bracket; 21, second housing; 211, second plate; 2111, second heat-dissipation hole; 212, second cover; 210, second accommodating space; 22, second charging assembly; 221, second induction coil; 222, second master control member; 23, mounting table; 231, mounting slot; 232, handle slot;
30, charging cantilever; 31, third housing; 311, first half-housing; 3111, rectangular structure; 3112, circular structure; 312, second half-housing; 32, third charging assembly;
40, rotating-shaft structure; 41, rotating-shaft seat; 411, through-hole; 412, seat; 413, mounting block; 42, damping spindle; 421, first portion; 4211, first shaft; 4212, first connecting block; 4213, elastic sheet; 4214, fastening nut; 4215, angular-limiting block; 4216, angular-limiting ring; 422, second portion; 4221, second shaft; 4222, second connecting block; 4223, fixing block; 4224, fixing slot; 43, spring;
200, first product;
300, second product;
400, third product;
o1, rotation axis; o2, rotation axis.

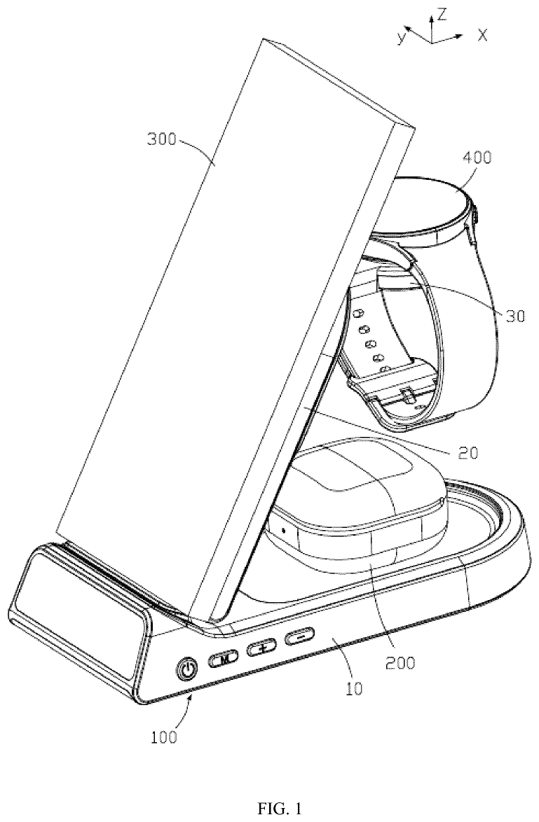

Referring to FIG. 1, an embodiment of the present disclosure provides a wireless charging device 100 for charging a first product 200, a second product 300, and a third product 400. The wireless charging device 100 is capable of charging the first product 200, the second product 300, and the third product 400 at the same time, or is capable of charging either one or both of them at the same time. The user can charge three products at the same time to improve the charging efficiency, and can also select a specific product for charging according to actual needs, which is highly flexible.

The first product 200, the second product 300 and the third product 400 are all electronic products, optionally, the first product 200 is an earbuds charging compartment, the second product 300 is a cell phone and the third product 400 is a watch. It should be noted that the second product 300 is not limited to a cell phone, but may also be other plate-like electronic products, such as a computer tablet.

The wireless charging device 100 includes a charging base 10, a charging bracket 20 and a charging cantilever 30. For ease of description, a coordinate system is established in FIG. 1 of the present disclosure, and subsequent orientations with respect to the wireless charging device 100 are based on this coordinate system. The length direction of the charging base 10 extends along the X-axis direction, the width direction of the charging base 10 extends along the Y-axis direction, and the height direction of the charging base 10 extends along the Z-axis direction. It should be noted that the reference of this coordinate system is the charging base 10, i.e., when the charging bracket 20 and the charging cantilever 30 move with respect to the charging base 10, the position of this coordinate system does not change.

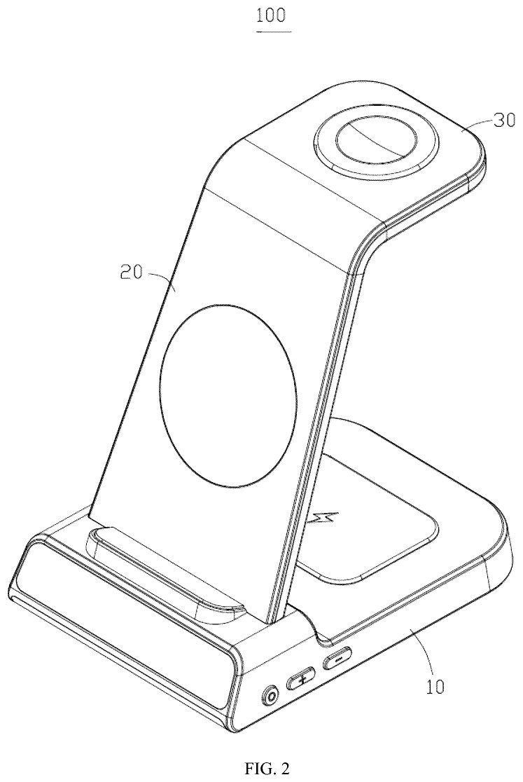

Referring to FIG. 2, in some embodiments, the bottom surface of the charging base 10 is substantially parallel to the plane formed by the X-axis and the Y-axis. The charging bracket 20 is fixedly connected to the charging base 10 at one end thereof and fixedly connected to the charging cantilever 30 at the other end thereof. The extension direction of the charging bracket 20 is inclined with respect to the Z-axis, and the bottom surface of the charging cantilever 30 is substantially parallel to the plane formed by the X-axis and the Y-axis. The charging base 10 is used to charge the first product 200, the charging bracket 20 is used to charge the second product 300, and the charging cantilever 30 is used to charge the third product 400.

In other embodiments, the charging base 10, the charging bracket 20 and the charging cantilever 30 are connected to each other by being rotatable with respect to each other, specifically, the charging bracket 20 is rotatably connected to the charging base 10 to cause the charging bracket 20 and the charging base 10 to be folded or unfolded with each other. The charging cantilever 30 is rotatably connected to the charging bracket 20 so as to cause the charging cantilever 30 and the charging bracket 20 to be folded or unfolded with respect to each other. The rotation axis o1 of the charging bracket 20 and the rotation axis o2 of the charging cantilever 30 are both extended along the Y-axis direction.

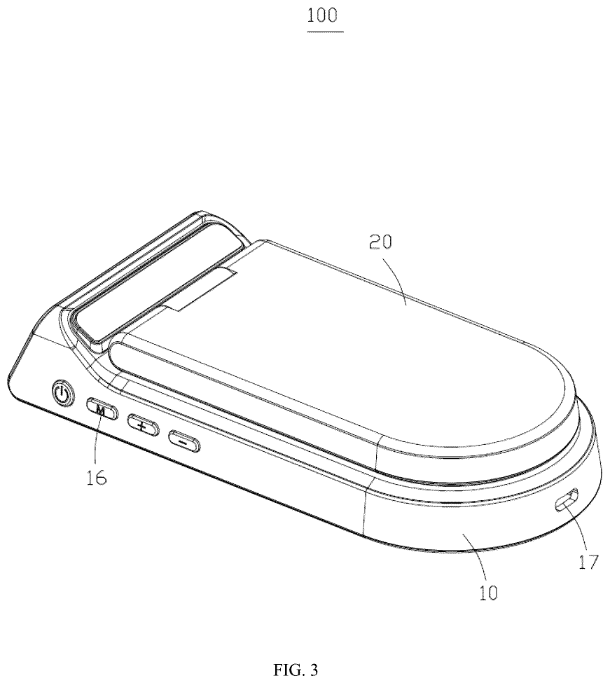

Referring to FIGS. 3, 4, and 5, the wireless charging device 100 has a first form, a second form, and a third form. As shown in FIG. 2, when the wireless charging device 100 is in the first form, the charging bracket 20 is folded with the charging base 10, and the charging cantilever 30 is folded with the charging bracket 20 to make the wireless charging device 100 a substantially rectangular shape to facilitate portability, and the second product 300 can be placed directly on the side of the charging bracket 20 away from the charging base 10 to charge the second product 300.

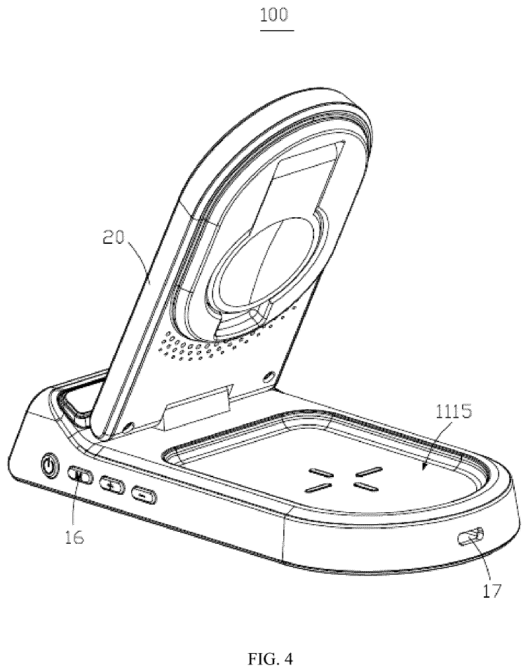

As shown in FIG. 4, when the wireless charging device 100 is in the second form, the charging bracket 20 is unfolded with the charging base 10 and the charging cantilever 30 is folded with the charging bracket 20. The side of the charging base 10 close to the charging bracket 20 is used for charging the first product 200. The side of the charging bracket 20 away from the charging base 10 couples with the charging base 10 for positioning the second product 300, and the charging bracket 20 is used for charging the second product 300.

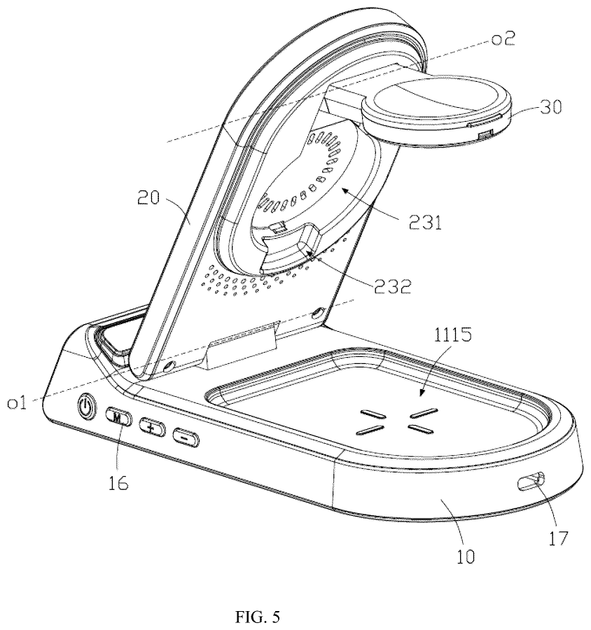

As shown in FIG. 5, when the wireless charging device 100 is in the third form, the charging bracket 20 is unfolded with the charging base 10, and the charging cantilever 30 is unfolded with the charging bracket 20, and the charging cantilever 30 is used to charge the third product 400.

The wireless charging device 100 has multiple forms. When in the first form, the wireless charging device 100 can be easily carried and charge the second product 300. When in the second form, at least one of the first product 200 and the second product 300 can be charged. When in the third form, at least one of the first product 200, the second product 300, and the third product 400 can be charged. The wireless charging device 100 is versatile and flexible.

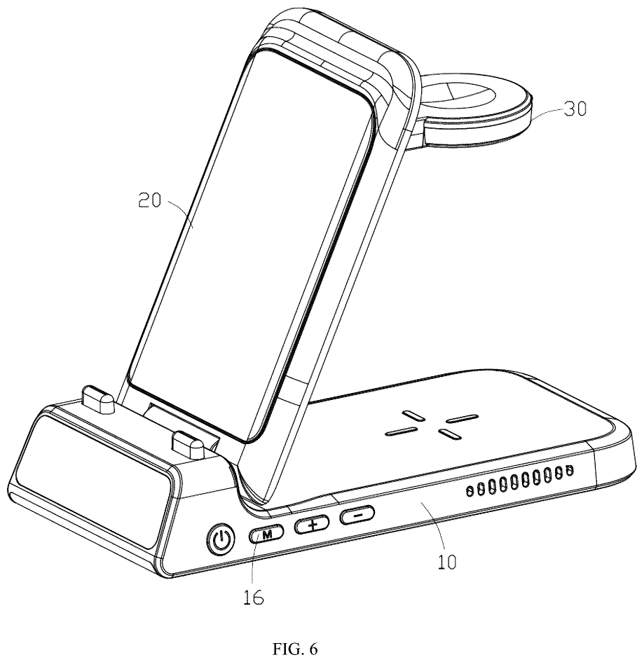

Referring to FIG. 5, during use, the charging base 10 is typically placed on a work surface for support. The work surface is to be understood as a desktop, a floor, and the like. It should be noted that the shape of the charging base 10 is not limited, for example, as shown in FIG. 5, the charging base 10 has a rectangular shape at one end and a curved shape at the other end, which is roughly in the shape of a semi-runway. Another example is that the charging base 10 is rectangular at both ends and the charging base 10 has a roughly rectangular shape, as shown in FIG. 6.

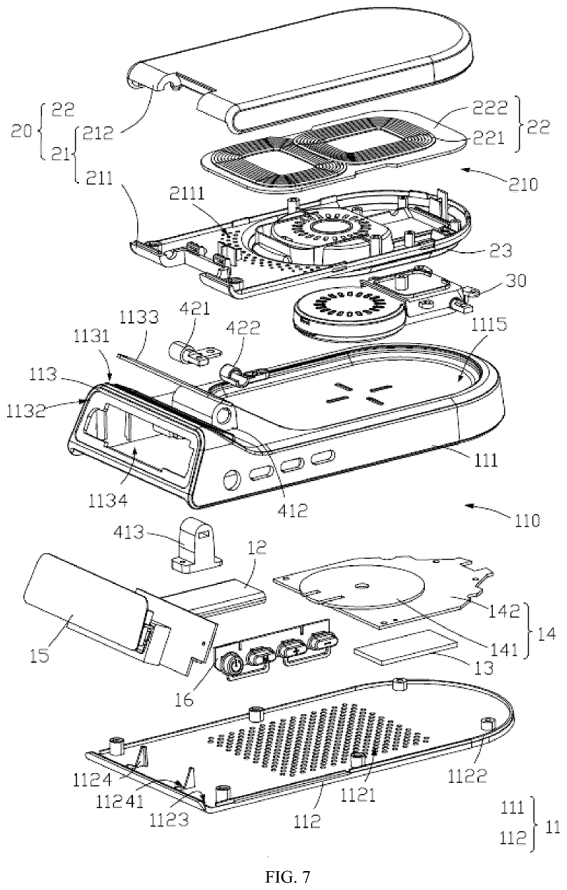

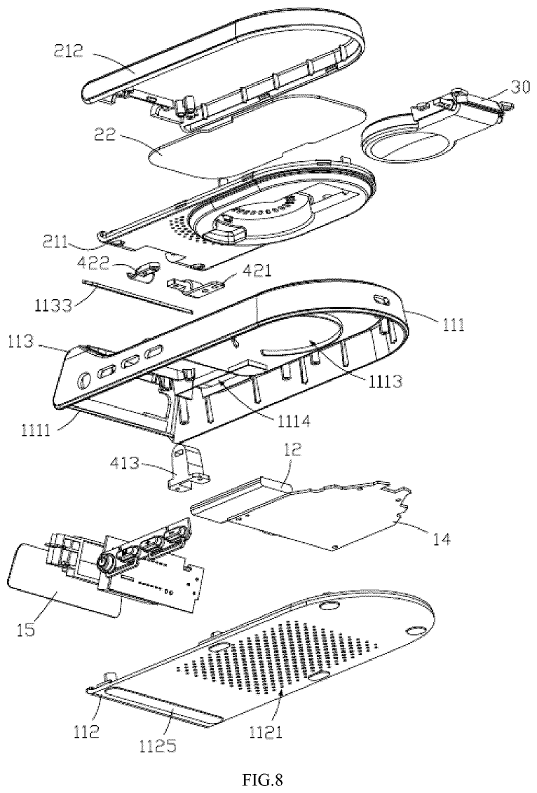

Referring to FIGS. 7 and 8, the charging base 10 includes a first housing 11, a battery 12, a control module 13, and a first charging assembly 14. The first housing 11 is provided with a first accommodating space 110, and the first housing 11 is rotatably connected to the charging bracket 20. The battery 12 is disposed in the first accommodating space 110. The control module 13 is disposed in the first accommodating space 110 and located on one side of the battery 12, and the control module 13 is electrically connected to the battery 12. The first charging assembly 14 is disposed in the first accommodating space 110 and connected to the control module 13.

When the wireless charging device 100 is in the second form or the third form, after placing the first product 200 on the side of the first housing 11 close to the charging bracket 20, the control module 13 can control the battery 12 to wirelessly charge the first product 200 through the first charging assembly 14. The charging manner thereof is simple and fast.

In some embodiments, the first charging assembly 14 includes a first induction coil 141 and a first master control member 142. The first induction coil 141 and the first master control member 142 are both disposed in the first accommodating space 110, and the first induction coil 141 is disposed in the first master control member 142, and the first master control member 142 is connected to the control module 13. The first product 200 can be charged after the first product 200 is placed in the first housing 11 in a position corresponding to the first induction coil 141.

In some embodiments, the first housing 11 includes a first cover 111 and a first plate 112, the first cover 111 is disposed on an upper side of the first plate 112, and the first cover 111 and the first plate 112 enclose to form the first accommodating space 110.

The first plate 112 is provided with a plurality of first heat-dissipation holes 1121 along the Z-axis direction, and the plurality of first heat-dissipation holes 1121 are arranged in a rectangular array, such that the external air can pass through the first heat-dissipation holes 1121 and enter into the first accommodating space 110 to dissipate heat from the first charging assembly 14 and the control module 13. Optionally, a spacer 1125 is disposed at the bottom of the first plate 112 to increase the stability of the first plate 112.

In some embodiments, along the X-axis direction, one end of the first plate 112 is arcuate and upwardly curved, and the arcuate is provided with a connecting slot 1123. The connecting slot 1123 runs through opposing sides of the first plate 112 along the Y-axis direction, as well as runs through the connecting plate along the Z-axis direction. A connecting strip 1111 is provided at a corresponding position of the first cover 111, and the connecting strip 1111 is inserted into the connecting slot 1123, thereby limiting the position of the first plate 112 and the first cover 111, so as to make one end of the first housing 11 transition in an arc shape and have better sealing performance.

In some embodiments, a sealing strip 1122 is provided on an upper surface of the first plate 112, and the sealing strip 1122 is disposed around the projection of the first plate 112 in the Z-axis direction. A plurality clamping blocks 1112 are provided on the inner side wall of the first cover 111, and the clamping blocks are arranged in a spaced apart manner around the inner side wall of the first cover 111. Each of the clamping blocks 1112 is configured to couple with the sealing strip 1122, so as to limit the relative position of the first cover 111 and the first plate 112, and to block dust and impurities from entering the first accommodating space 110.

In some embodiments, the first cover 111 is provided with a first mounting position 1113 and a second mounting position 1114 at the top of the inner side of the first cover 111. The first mounting position 1113 is used for mounting the first charging assembly 14 and the control module 13, and the second mounting position 1114 is used for mounting the battery 12, such that the first charging assembly 14, the control module 13, and the battery 12 can be kept out of contact with the first plate 112 to reduce the occurrence of the first charging assembly 14, the control module 13, and the battery 12 blocking the first heat-dissipation hole 1121 and affecting heat dissipation. In addition, the first plate 112 is placed on a work surface, and when there is moisture on the work surface, the water can enter the first accommodating space 110 through the first heat-dissipation hole 1121. The first charging assembly 14, the control module 13, and the battery 12 are not in contact with the first plate 112, which can reduce the contact of water with the parts and components in the first accommodating space 110 and can prolong the service life thereof. Further, the first mounting position 1113 and the second mounting position 1114 are located in the first cover 111, and when assembling the charging base 10, the first cover 111 is used as a reference for installation, and the first plate 112 has a simple and thin structure, which makes it easy to install to the first cover 111.

In some embodiments, a positioning table 113 is formed on the upper side of the first cover 111, and the positioning table 113 is configured to couple with the charging bracket 20 for positioning the second product 300. The positioning table 113 has a generally triangular shape.

The second product 300 is stably supported by the positioning table 113 cooperating with the charging bracket 20. In addition, when the wireless charging device 100 is in the second or third form, the positioning table 113 couples with the charging bracket 20 to form a support, which facilitates the user to watch the contents played by the second product 300 when the second product 300 is placed at the positioning table 113 and the charging bracket 20 such that the user can use the second product 300 while charging.

In some embodiments, the positioning table 113 has a first side 1131 and a second side 1132 intersected with the first side 1131, and the first side 1131 is used to position the second product 300 in conjunction with the charging bracket 20.

In some embodiments, the first side 1131 is provided with a protective pad 1133, and the first side 1131 is configured to couple with the charging bracket 20 to position the second product 300 via the protective pad 1133. Friction with the second product 300 is increased via the protective pad 1133, which enhances the stability of the second product 300.

The second side 1132 is provided with an avoidance slot 1134, and the charging base 10 further includes a display module 15. The display module 15 is provided in the avoidance slot 1134, and the display module 15 is connected to the control module 13. The display module 15 is used to display information, and the displayed information includes but is not limited to time, date, temperature, humidity, charging status, and remaining power.

By providing the display module 15, the user can accurately know the remaining power, and the display module 15 is located in the avoidance slot 1134 of the second side 1132, such that when the user charges the second product 300 while using the second product 300, the display module 15 can face the user directly to facilitate the user to know the remaining power in time.

In some embodiments, the first plate 112 is provided with positioning blocks 1124, and the number of the positioning blocks 1124 is two. The two positioning blocks 1124 are spaced apart along the Y-axis direction, and each positioning block 1124 is provided with a slot 11241 clamped with the display module 15 to position the display module 15. The display module 15 is positioned simply and conveniently.

In some embodiments, the charging base 10 further includes a key module 16, and the key module 16 is partially disposed within the first accommodating space 110 and partially exposed from a side wall of the first cover 111 for a user to press to select, and the key module 16 is connected to the control module 13.

In some embodiments, the charging base 10 further includes a charging module 17, and the charging interface of the charging module 17 is exposed, from one end of the first cover 111, out of the first cover 111. The charging module 17 is connected to the control module 13 and used for charging the battery 12.

The charging bracket 20 is rotatably connected to the charging base 10 such that the wireless charging device 100 is capable of being folded to the first form or unfolded to the second form. In some embodiments, the wireless charging device 100 further includes a rotating-shaft structure 40 connected to the first cover 111 of the charging base 10 and connected to the charging bracket 20 to cause the charging base 10 and the charging bracket 20 to rotate with respect to each other.

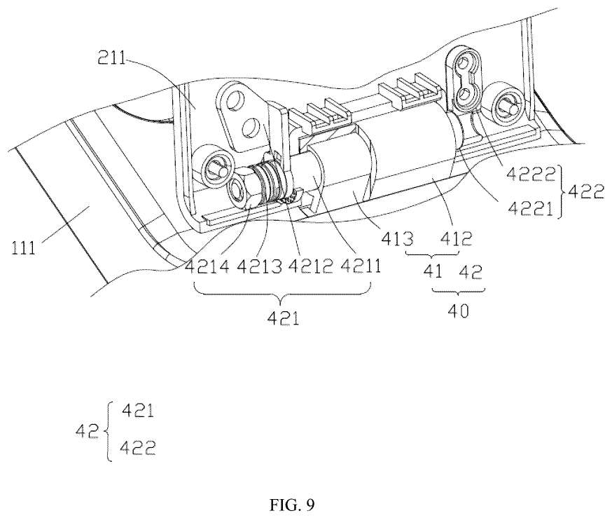

Referring to FIGS. 8, 9, and 10, the rotating-shaft structure 40 includes a rotating-shaft seat 41 and a damping spindle 42. The rotating-shaft seat 41 is disposed in the first cover 111 of the charging bracket 10, the rotating-shaft seat 41 is provided with a through-hole 411, and the through-hole 411 passes through the rotating-shaft seat 41 along the direction of the Y-axis. The damping spindle 42 is threaded through the through-hole 411 and connected to the charging bracket 20.

The damping spindle 42 causes the position of the charging bracket 20 to remain stable when the wireless charging device 100 is in the second form, and the charging bracket 20 is capable of stepless adjustment, such that the charging bracket 20 can remain stable at any position within the rotatable range.

In some embodiments, the damping spindle 42 is rotatably connected to the rotating-shaft seat 41, and the damping spindle 42 remains relatively fixed to the charging bracket 20 to cause the charging bracket 20 to rotate with respect to the charging base 10.

In other embodiments, the damping spindle 42 remains relatively fixed to the rotating-shaft seat 41, and the damping pivot 42 is rotatably connected to the charging bracket 20 to cause the charging bracket 20 to rotate with respect to the charging base 10.

In other embodiments, the damping spindle 42 includes a first portion 421 and a second portion 422, and the first portion 421 and the second portion 422 are spaced apart in the Y-axis direction. The first portion 421 is located at one end of the rotating-shaft seat 41 and threaded through the through-hole 411, and the first portion 421 is connected to the charging bracket 20. The second portion 422 is disposed at the other end of the rotating-shaft seat 41 and is threaded through the through-hole 411, and the second portion 422 is connected to the charging bracket 20.

Optionally, the first portion 421 remains at least partially fixed with respect to the rotating-shaft seat 41, and the first portion 421 and the charging bracket 20 are at least partially capable of rotating with respect to each other. The second portion 422 is fixedly connected to the rotating-shaft seat 41.

In some embodiments, the first portion 421 includes a first shaft 4211, a first connecting block 4212, an elastic sheet 4213, and a fastening nut 4214. The first shaft 4211 is threaded through the through-hole 411 and is connected to the rotating-shaft seat 41. The first connecting block 4212 is rotatably connected to the first shaft 4211, and the first connecting block 4212 is fixedly connected to the charging bracket 20. The elastic sheet 4213 is threaded through the first shaft 4211 and is in direct contact with the first connecting block 4212, and the fastening nut 4214 is threadedly connected to the first shaft 4211.

By contacting the elastic sheet 4213 with the first connecting block 4212, the friction of the first connecting block 4212 can be increased so as to provide a damping effect, and the strength of the elastic sheet 4213 against the first connecting block 4212 can be adjusted by adjusting the position of the fastening nut 4214, so as to adjust the damping effect of the charging bracket 20 when rotating.

In some embodiments, along the Y-axis direction, the through-hole 411 is partially circular and partially rectangular. The first shaft 4211 includes a column and a rectangular body sequentially connected along the Y-axis direction. The column is disposed in the circular portion of the through-hole 411, and the rectangular body is disposed in the rectangular portion of the through-hole 411, such that the first shaft 4211 can be kept stable with respect to the rotating-shaft seat 41.

In some embodiments, the rotating-shaft seat 41 includes a seat 412 and a mounting block 413, and the through-hole 411 penetrates the seat 412 and the mounting block 413. The seat 412 protrudes from an upper surface of the first cover 111, and the mounting block 413 is disposed within the seat 412 from an inner top surface of the first cover 111. A rectangular portion of the through-hole 411 is disposed in the mounting block 413.

Splitting the rotating-shaft seat 41 into the seat 412 and the mounting block 413 causes the first cover 111 to be molded integrally with the seat body 412 to maintain the stability of the rotating-shaft seat 41, and the mounting block 413 can be produced separately to facilitate the formation of the rectangular portion of the through-hole 411.

In some embodiments, the first connecting block 4212 is provided with an angular-limiting block 4215, the first shaft 4211 is provided with an angular-limiting ring 4216, and the angular-limiting block 4215 is in contact with the angular-limiting ring 4216 to limit the rotational range of the charging bracket 20.

In some embodiments, the second portion 422 includes a second shaft 4221 and a second connecting block 4222. The second shaft 4221 extends in the Y-axis direction and is threaded through the through-hole 411 where the seat 412 is located. The second connecting block 4222 is fixedly connected to the second shaft 4221, and the second connecting block 4222 is fixedly connected to the charging bracket 20.

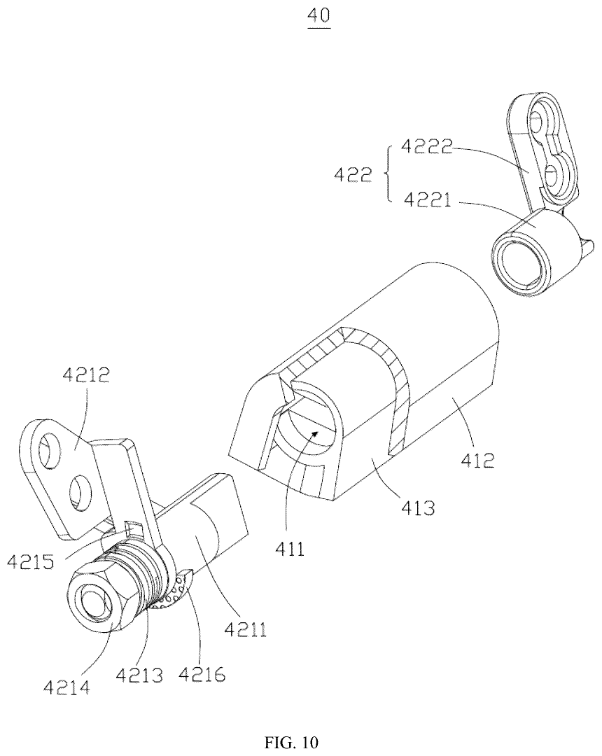

Referring to FIG. 10, in some embodiments, both the first portion 421 and the second portion 422 are capable of sliding with respect to the rotating-shaft seat 41, and the sliding direction thereof is parallel to the Y-axis direction.

The second portion 422 is provided with a fixing block 4223, and the rotating-shaft seat 41 is provided with a plurality of fixing slots 4224. The plurality of fixing slots 4224 are spaced apart around the rotation axis o1 of the charging bracket 20. By moving the charging bracket 20, the first portion 421 and the second portion 422 are driven to slide with respect to the rotating-shaft seat 41, such that the fixing block 4223 can extend into or disengage from one of the fixing slots 4224. When the fixing block 4223 extends into the fixing slot 4224, the rotation of the charging bracket 20 will be limited, which can improve the stability of the charging bracket 20 and can also maintain the stability of the charging bracket 20 when the second product 300 is an electronic product such as pad with a large mass. When the fixing block 4223 is disengaged from the fixing slot 4224, the charging bracket 20 can rotate with respect to the charging base 10. The charging bracket 20 is rotated or fixed simply and conveniently.

In some embodiments, the rotating-shaft structure 40 further includes a spring 43 sleeved to the first shaft 4211 of the first portion 421, and the spring 43 is used to push the first portion 421 and drive the fixing block 4223 to extend into the fixing slot 4224 through the charging bracket 20 and the second portion 422 to maintain the fixation of the charging bracket 20.

When the angle of the charging bracket 20 with respect to the charging base 10 needs to be adjusted, the user can push the charging bracket 20 along the Y-axis direction to separate the fixing block 4223 from the fixing slot 4224. When adjusted to an appropriate position, lift the force exerted on the charging bracket 20, and push the fixing block 4223 to extend into the fixing slot 4224 under the action of the spring 43, thereby limiting the rotation of the charging bracket 20. The operation thereof is simple and convenient.

Referring to FIGS. 7 and 8, in some embodiments, the first cover 111 of the charging base 10 is provided with a positioning slot 1115 on one side of the first cover 111 close to the charging bracket 20, and the positioning slot 1115 is used to place the first product 200. At least a portion of the charging bracket 20 and the charging cantilever 30 are located in the positioning slot 1115 when the wireless charging device 100 is in the first form.

The positioning slot 1115 can facilitate placing the first product 200, and when the wireless charging device 100 is in the first form, the charging bracket 20 is at least partially disposed in the positioning slot 1115, i.e., the thickness of the charging bracket 20 corresponding to the location of the positioning slot 1115 can be increased, so as to facilitate the installation of the internal parts of the charging bracket 20 and to improve the space utilization rate.

In some embodiments, the charging bracket 20 includes a second housing 21 and a second charging assembly 22. The second housing 21 is rotatably connected to the first housing 11 of the charging base 10 via the rotating-shaft structure 40, and the first connecting block 4212 and the second connecting block 4222 of the rotating-shaft structure 40 are both connected to the second housing 21. The second housing 21 is provided with a second accommodating space 210. The second charging assembly 22 is disposed in the second housing 21, and the second charging assembly 22 is used to charge the second product 300.

The second housing 21 is rotated by the rotating-shaft structure 40 to rotate with respect to the charging base 10, so as to facilitate adjustment of the form of the wireless charging device 100. The second product 300 can be placed on the side of the second housing 21 away from the charging base 10, and the second housing 21 couples with the positioning table 113 to position the second product 300. The second charging assembly 22 can wirelessly charge the second product 300, and the charging method of the second product 300 is simple.

In some embodiments, the second housing 21 protrudes toward the charging base 10 to form a mounting table 23, and the mounting table 23 is provided with a mounting slot 231. When the wireless charging device 100 is in the first form, the mounting table 23 is located in the positioning slot 1115 and the charging cantilever 30 is located in the mounting slot 231.

The volume of the second accommodating space 210 can be increased by the mounting table 23, and there is sufficient space to provide the mounting slot 231 such that the charging cantilever 30 can be located in the mounting slot 231. The space utilization rate thereof can be improved.

In some embodiments, the mounting platform 23 is further provided with a handle slot 232 connected to the mounting slot 231. The handle slot 232 can facilitate snapping the charging cantilever 30 out of the mounting slot 231 so as to facilitate an enhanced user experience.

In some embodiments, the second housing 21 includes a second plate 211 and a second cover 212 connected to the second plate 211. The second plate 211 and the second cover 212 enclose to form the second accommodating space 210. The first connecting block 4212 and the second connecting block 4222 are disposed within the second accommodating space 210 and connected to the second cover 212. The mounting table 23 is provided on a side of the second plate 211 away from the second cover 212. The second plate 211 is provided with a second heat-dissipation hole 2111 adjacent to the mounting table 23.

The side of the second cover 212 away from the second plate 211 is used to place the second product 300, and the second cover 212 is configured to couple with the positioning table 113 to position the second product 300.

In some embodiments, the second charging assembly 22 includes a second induction coil 221 and a second master control member 222, and the second induction coil 221 and the second master control member 222 are both disposed in the second accommodating space 210. The second induction coil 221 is disposed at the second master control member 222, and the second master control member 222 is connected to the control module 13. After placing the second product 300 in the second housing 21, the second charging assembly 22 is capable of charging the second product 300 in a simple and fast manner.

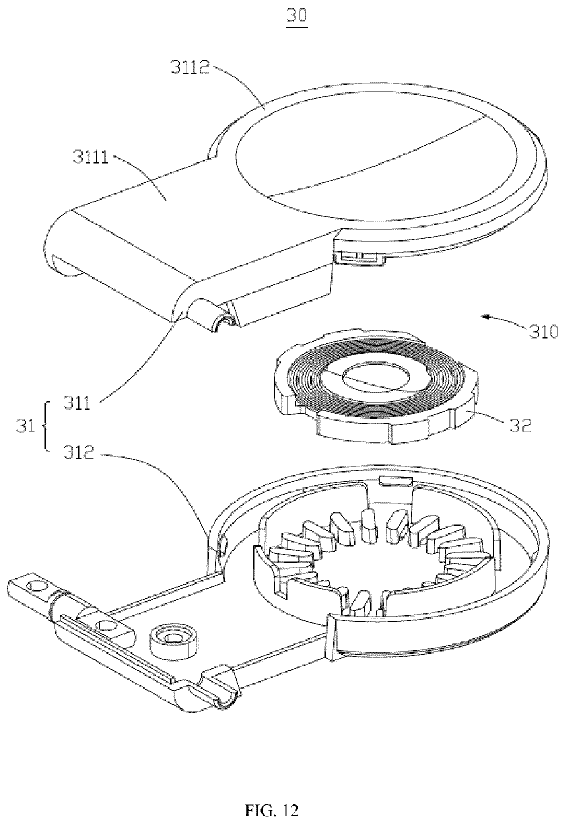

Referring to FIGS. 7, 8, and 12, in some embodiments, the charging cantilever 30 includes a third housing 31 and a third charging assembly 32. The third housing 31 is rotatably connected to the charging bracket 20, and the third housing 31 is provided with a third accommodating space. The third charging assembly 32 is located in the third accommodating space, and the third charging assembly 32 is electrically connected to the control module 13 for charging the third product 400.

In some embodiments, the third housing 31 includes a first half-housing 311 and a second half-housing 312, and the first half-housing 311 and the second half-housing 312 enclose to form the third accommodating space. When the wireless charging device 100 is in the third form, a side of the first half-housing 311 away from the second half-housing 312 is in direct contact with the third product 400. When the wireless charging device 100 is in the first form or the second form, the second half-housing 312 is in direct contact with the slot bottom of the mounting slot 231.

The first half-housing 311 and the second half-housing 312 have the same shape and both include a rectangular structure 3111 and a circular structure 3112. One end of the rectangular structure 3111 is rotatably connected to the charging bracket 20, and the other end thereof is connected to the circular structure 3112. The third product 400 is placed on the circular structure 3112 of the first half-housing 311.

In some embodiments, when the wireless charging device 100 is in the second form, the rectangular structure 3111 is located above the circular structure 3112. After the charging cantilever 30 rotates upwardly, the wireless charging device 100 is in the third form and the distance between the charging cantilever 30 and the charging base 10 is increased such that when the third product 400 is placed on the charging cantilever 30 for charging, the third product 400 and the charging base 10 will not interfere.

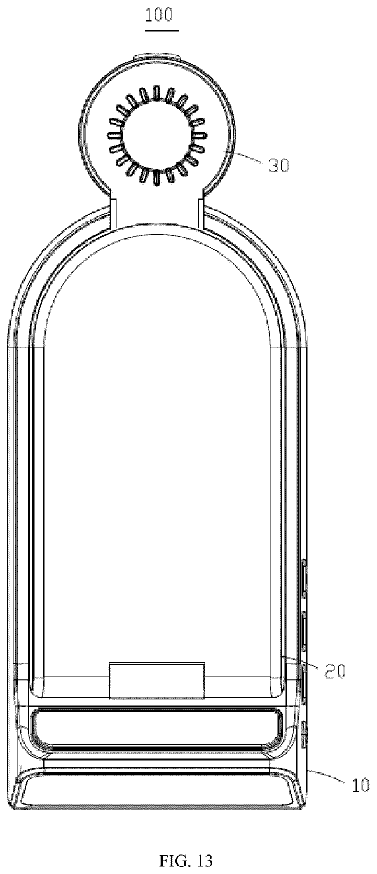

Referring to FIG. 13, in other embodiments, when the wireless charging device 100 is in the second form, the rectangular structure 3111 is located below the circular structure 3112. The charging cantilever 30 is rotated downwardly such that the wireless charging device 100 is in the third form. The housing of the charging cantilever 30 is slidingly connected to the charging bracket 20, such that when the wireless charging device 100 is in the first form and the charging bracket 20 is folded with the charging base 10, the charging cantilever 30 can slide with respect to the charging bracket 20 and extend out of the charging bracket 20. Neither the rectangular structure 3111 nor the circular structure 3112 will interfere with the charging bracket 20 during sliding.

Thus, if only the third product 400 needs to be charged, the charging cantilever 30 can be pulled out when the wireless charging device 100 is in the first form, such that the charging cantilever 30 can charge the third product 400. The wireless charging device 100 charges more flexibly and diversely.

In summary, the present disclosure provides a wireless charging device 100, which is capable of charging a first product 200, a second product 300, and a third product 400 correspondingly by means of a charging base 10, a charging bracket 20, and a charging cantilever 30, and is capable of charging a variety of products.

The above are only specific embodiments of the present disclosure, but the protection scope of the present disclosure is not limited thereto. Any person familiar with the technical field can easily think of various equivalent modifications or substitutions within the technical scope disclosed in the present disclosure, and these modifications or substitutions should be covered by the protection scope of the present disclosure. Therefore, the protection scope of the present disclosure should be subject to the protection scope of the claims.

What is claimed is:

1. A wireless charging device, comprising:
a charging base for charging a first product;
a charging bracket for charging a second product; the charging bracket being rotatably connected to the charging base to cause the charging bracket and the charging base to be folded or unfolded with respect to each other; when the charging bracket is unfolded with respect to the charging base, the charging bracket being configured to couple with the charging base to position the second product;
a charging cantilever for charging a third product; the charging cantilever being rotatably connected to the charging bracket to cause the charging cantilever and the charging bracket to be folded or unfolded with respect to each other; a rotation axis of the charging bracket being parallel to a rotation axis of the charging cantilever.

2. The wireless charging device according to claim 1, wherein a positioning slot is provided at a side of the charging base close to the charging bracket, and the positioning slot is configured to place the first product; when the wireless charging device is in a first form, at least part of the charging bracket and the charging cantilever being located in the positioning slot.

3. The wireless charging device according to claim 1, wherein the charging base comprises:
a first housing rotatably connected to the charging bracket; the first housing having a first accommodating space;
a battery disposed in the first accommodating space;
a control module disposed in the first accommodating space and located on one side of the battery; the control module being electrically connected to the battery;
a first charging assembly disposed in the first accommodating space and connected to the control module.

4. The wireless charging device according to claim 3, wherein the first housing comprises a first cover and a first plate, and the first cover and the first plate enclose to form the first accommodating space; the first cover being rotatably connected to the charging bracket; the first cover having a positioning table formed on an upper side thereof, and the positioning table is configured to couple with the charging bracket to position the second product.

5. The wireless charging device according to claim 4, wherein the positioning table has a first side and a second side intersected with the first side; the first side being configured to couple with the charging bracket to position the second product, and the second side being provided with an avoidance slot; the charging base further comprising:
a display module disposed in the avoidance slot and connected to the control module.

6. The wireless charging device according to claim 5, wherein the first side is provided with a protective pad, and the first side is configured to couple with the charging bracket to locate the second product via the protective pad.

7. The wireless charging device according to claim 5, wherein the first plate is provided with a locating block, and the locating block is provided with a slot clamped with the display module.

8. The wireless charging device according to claim 1, wherein the charging bracket comprises:
a second housing rotatably connected to the charging base, the second housing having a second accommodating space;
a second charging assembly disposed in the second accommodating space, the second charging assembly being configured to charge the second product.

9. The wireless charging device according to claim 8, wherein a side of the charging base close to the charging bracket is provided with a positioning slot; the second housing being provided with a mounting table protruding towards the charging base, and the mounting table being provided with a mounting slot; when the wireless charging device is in a first form, the mounting table being located in the positioning slot and the charging cantilever being located in the mounting slot.

10. The wireless charging device according to claim 9, wherein the mounting table is further provided with a handle slot communicated with the mounting slot.

11. The wireless charging device according to claim 1, wherein the wireless charging device further comprises a rotating-shaft structure connected to the charging base and the charging bracket to cause the charging base and the charging bracket to rotate with respect to each other.

12. The wireless charging device according to claim 11, wherein the rotating-shaft structure comprises:
a rotating-shaft seat disposed at the charging base, the rotating-shaft seat being provided with a through-hole;
a damping spindle threaded through the through-hole and connected to the charging bracket.

13. The wireless charging device according to claim 12, wherein the damping spindle comprises:
a first portion located at one end of the rotating-shaft seat and threaded through the through-hole, the first portion being connected to the charging bracket;
a second portion spaced apart from the first portion along the rotation axis of the charging bracket, the second portion being located at an opposite end of the rotating-shaft seat and threaded through the through-hole, the second portion being connected to the charging bracket.

14. The wireless charging device according to claim 13, wherein the first portion comprises:
a first shaft threaded through the through-hole and connected to the rotating-shaft seat;
a first connecting block rotatably connected to the first shaft, the first connecting block being fixedly connected to the charging bracket;
an elastic sheet threaded through the first shaft and in direct contact with the first connecting block;
a fastening nut threadedly connected to the first shaft.

15. The wireless charging device according to claim 14, wherein the first connecting block is provided with an angular-limiting block, the first shaft is provided with an angular-limiting ring, and the angular-limiting block is in contact with the angular-limiting ring to limit a rotation range of the charging bracket.

16. The wireless charging device according to claim 13, wherein the second portion is provided with a fixing block, and the rotating-shaft seat is provided with a plurality of fixing slots spaced apart around the rotation axis of the charging bracket;
the first portion and the second portion being both slidingly connected to the rotating-shaft seat and a sliding direction thereof extending in a direction of the rotation axis of the charging bracket, so as to cause the fixing block to extend into or to disengage from one of the fixing slots;
when the fixing block extends into a fixing slot, a rotation of the charging bracket being limited; when the fixing block is disengaged from the fixing slot, the charging bracket can rotate with respect to the charging base.

17. The wireless charging device according to claim 16, wherein the rotating-shaft structure further comprises a spring sleeved to the first portion, the spring being configured to push the first portion such that the fixing block can extend into the fixing slot.

18. The wireless charging device according to claim 3, wherein the charging cantilever comprises:
a third housing rotatably connected to the charging bracket, the third housing having a third accommodating space;
a third charging assembly located in the third accommodating space, the third charging assembly being electrically connected to the control module to charge the third product.

19. The wireless charging device according to claim 1, wherein the charging cantilever is slidably connected to the charging bracket, and when the charging bracket is folded with the charging base, the charging cantilever can slide with respect to the charging bracket and extends out of the charging bracket.

20. The wireless charging device according to claim 1, wherein the first product is an earbuds charging compartment, the second product is a cell phone, and the third product is a watch.
